(19) United States
(12) Patent Application Publication
(10) Pub. No.: US 2012/0125918 A1
(43) Pub. Date: May 24, 2012

(54) HOTPLATE HAVING AT LEAST TWO HEATING ZONES

(75) Inventors: Carlos Bernal Ruiz, La Puebla de Alfinden (ES); Ignacio Garde Aranda, Zaragoza (ES); Pilar Molina Gaudó, Zaragoza (ES); Fernando Monterde Aznar, Zaragoza (ES); Maria Elena Moya Albertin, Zaragoza (ES); Ramon Peinado Adiego, Zaragoza (ES); Diego Puyal Puente, Zaragoza (ES)

(73) Assignee: BSH BOSCH UND SIEMENS HAUSGERÄTE GMBH, Munich (DE)

(21) Appl. No.: 13/384,600

(22) PCT Filed: Jul. 8, 2010
(86) PCT No.: PCT/EP2010/059794

§ 371 Date: Jan. 18, 2012

(30) Foreign Application Priority Data
Jul. 29, 2009 (ES) P200930530

(51) Int. Cl. H05B 6/12

(52) U.S. Cl. 219/622

(57) ABSTRACT

A hotplate apparatus, in particular for a hotplate having a cover plate having at least two heating zones, includes a cooking utensil sensor unit. The cooking utensil sensor unit has at least one bridging detection unit, which is intended to detect at least bridging of the at least two heating zones by at least one cooking utensil element.

The invention relates to a hotplate comprising a cover plate and at least two heating zones according to the preamble of claim 1.

It is known, particularly in induction hotplates, to arrange cooking utensil sensors in the center of heating zones, said sensors being able to detect inductively or capacitively the presence of a cooking utensil element placed on the relevant heating zone.

In conventional hotplates with a predetermined cooktop surface with, for example, two or four heating zones, each having a predetermined edge, the inductors of the heating zone are also used as sensors for detecting a cooking utensil element. In hotplates having a plurality of concentric ring-shaped heating elements which can be switched on or off depending on the diameter of the cooking utensil element, and in hotplates with movable heating elements, of the type disclosed, for example, in DE 199 07 596 A1, arrangements having a plurality of sensors assigned to different radii are known, although the sensors are always arranged within the heating zone.

DE 102 07 183 B4 discloses an induction hotplate having four heating zones in which marking of the heating zones is dispensed with. In order to detect a cooking utensil element extending beyond the edge of a heating zone or to detect a large cooking utensil element which overlaps a plurality of heating zones, sensors and control means which are not described in detail are provided. DE 102 07 183 B4 also teaches configuring the induction coils such that the whole area of the hotplate is filled as far as possible, so that inactive regions of the hotplate are avoided where possible.

Previously, it has not been possible in hotplates with conventional cooktop surfaces to differentiate a situation in which two cooking pots are placed on adjacent heating zones from a situation in which a single elongate cooking pot, for example, a casserole, at least partially covers both the heating zones. In both cases, the cooking utensil sensors of both heating zones respond in the same way.

It is, in particular, the object of the invention to provide a hotplate with a sensor arrangement which can reliably detect large cooking utensil elements which cover at least two heating zones.

This is aim is achieved, in particular, by a hotplate having the features of claim 1. Advantageous embodiments and developments of the invention are disclosed by the subclaims.

The invention is based, in particular, on a hotplate apparatus, particularly for a hotplate with a cover plate, which includes at least two heating zones, and having a cooking utensil sensor unit. A “cover plate” is to be understood, in particular, as an element of the hotplate which, particularly, directly supports a cooking utensil element during a cooking procedure. Preferably, during a cooking procedure, the cover plate is at least partially arranged between a heating element and the cooking utensil element. A “heating zone” is to be understood, in particular, as a region of the cover plate which is provided in order to conduct energy from the heating element to the cooking utensil element. The heating zones advantageously each have at least one predetermined outer edge which at least substantially corresponds to the outer edge of a heating element arranged beneath the cover plate. Said outer edge separates the active regions of the hotplate from the inactive regions of the hotplate and delimits the interior of the heating zones from the exterior of the heating zones. In particular, the invention relates to hotplates with a conventional cooktop surface having two, four or six heating zones. Each heating zone can include adjacent heating elements arranged concentrically or to extend the heating zone to a roasting dish heating zone or a bridging roasting dish heating zone, so that the size of the heating zone can assume two or three values depending on the size and/or form of the cooking utensil element. Accordingly, the heating zone can also cover a plurality of predetermined edges. The edges of feely definable heating zones of a matrix cooking field should not be considered, in this relation, to be “predetermined” edges. A cooking utensil sensor unit should be understood, in particular, as a unit provided in order to determine at least one characteristic with information on the cooking utensil element. Preferably, the cooking utensil sensor unit has at least one cooking utensil sensor. Particularly preferably, the cooking utensil sensor unit has a cooking utensil sensor per heating zone. Alternatively or additionally, the cooking utensil sensor unit can have at least one further cooking utensil sensor outside the heating zones. Preferably, the cooking utensil sensor unit is configured at least partially integral with a control and/or regulating unit of the heating zones.

It is proposed, in particular, that the cooking utensil sensor unit has at least one bridging detection unit which is provided in order to detect at least one bridging of the at least two heating zones by means of at least one cooking utensil element. A “bridging detection unit” should be understood, in particular, to be a unit which comprises at least one evaluation unit and/or a special sensor for detecting the bridging. Preferably, the bridging detection unit is at least partially configured integrally with the control and/or regulating unit of the two heating zones. In particular, a “bridging” should be understood as a material connection of the two heating zones by means of the cooking utensil element. “Provided” should be understood, in particular, to mean specially programmed, configured and/or equipped. With the configuration according to the invention, it can, in particular, be ascertained whether a region of the cover plate outside the two heating zones, particularly between the two heating zones, is also covered by the cooking utensil element. If the two cooking utensil sensors arranged within the heating zones respond simultaneously, it is highly probable that the two heating zones and the intermediate space are jointly covered by a large cooking utensil element. If, however, the two sensors arranged within the heating zones respond while the further sensor arranged outside the heating zone does not respond, two different cooking utensil elements are probably positioned on the heating zones.

It is further proposed that the hotplate device has a control and/or regulating unit which is configured for operating the two heating zones matched to one another, dependent at least on the cooking utensil sensor unit, such that particularly easy use and particularly efficient operation can be achieved. In the case of induction hotplates, the operating frequencies of the inductors can be matched to one another in order to prevent destructive interference and/or buzzing of the hotplate. The expression “operating . . . matched to one another” should be understood to mean that, in the event of bridging, the control and/or computer unit adjusts, and particularly equalizes, at least one operating parameter that a person skilled in the art would deem suitable, for example an induction frequency, a heating output, a heating period and/or another operating parameter, of one of the heating zones to that of one of the other heating zones.

It is further proposed that the bridging detection unit is provided in order to detect a transference of energy from one of the heating zones to another of the heating zones, so that bridging can be detected by particularly simple design means. “Transference of energy” should be understood, in particular, to mean the conveying of energy by means of a cooking utensil element. The energy is preferably heat energy, electrical energy, magnetic energy and/or another form of energy deemed suitable by a person skilled in the art. Advantageously, the cooking utensil sensor is at least partially arranged within at least one of the two heating zones. Particularly advantageously, the same cooking utensil sensor is provided for detecting a cooking utensil element placed on the heating zone. Preferably, each heating zone comprises a cooking utensil sensor assigned to the heating zone and arranged, in particular, within the heating zone.

It is further proposed that the bridging detection unit comprises at least one cooking utensil sensor which is provided to detect a cooking utensil element in an inactive region of the cover plate between the two heating zones, so that particularly simple detection is possible. An “inactive region of the cover plate” should be understood to mean a region which is arranged outside a heating zone. Advantageously, the control and/or regulating unit is configured in order that, given simultaneous response of both the cooking utensil sensors arranged within the two heating zones and of the at least one further cooking utensil sensor arranged between the two heating zones, the two heating zones are operated in a manner matched to one another.

It is also proposed that the cooking utensil sensor is at a distance of at least 3 cm or 5 cm from the edges of the heating zones. In this way, faulty detection of a large cooking utensil element can be prevented, specifically in cases in which a cooking utensil element is placed on each of the heating zones, one of the cooking utensil elements extending beyond the lateral edge of the heating zone by a few centimeters, but does not cover both the heating zones simultaneously.

Asymmetry in the detection can be prevented if the at least one further cooking utensil sensor is at the same distance from the two mid-points of the two heating zones. Particularly reliable detection can be achieved if the hotplate is equipped with at least two further cooking utensil sensors arranged, in particular, symmetrically in relation to a connecting line between the two mid-points of the two heating zones in the inactive region of the cover plate outside the two heating zones.

It is further proposed that the further cooking utensil sensor is elongate and is arranged transversely to a connecting line of the two mid-points of the two heating zones in the inactive region of the cover plate outside the two heating zones.

The invention is usable, in particular, in induction hotplates having a conventional cooktop surface, for example, in hotplates with exactly four heating zones, each of which is heatable by an inductor.

In induction hotplates, the inductors can be used as the cooking utensil sensors arranged within the heating zone. The further cooking utensil sensors outside the edges of the heating zone can also be configured as inductive sensors.

Further advantages are disclosed in the following description of the drawings.

The drawings show exemplary embodiments of the invention. The drawings, the description and the claims contain numerous features in combination. A person skilled in the art would suitably also consider the features individually and group them together to further useful combinations.

In the drawings:

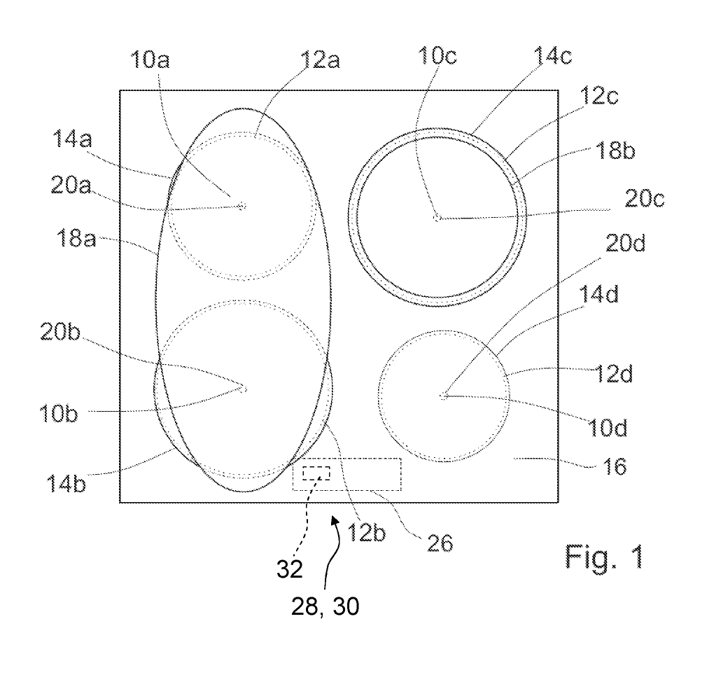

FIG. 1 is a hotplate with four heating zones and an elongate roasting dish covering two heating zones, in a schematic plan view,

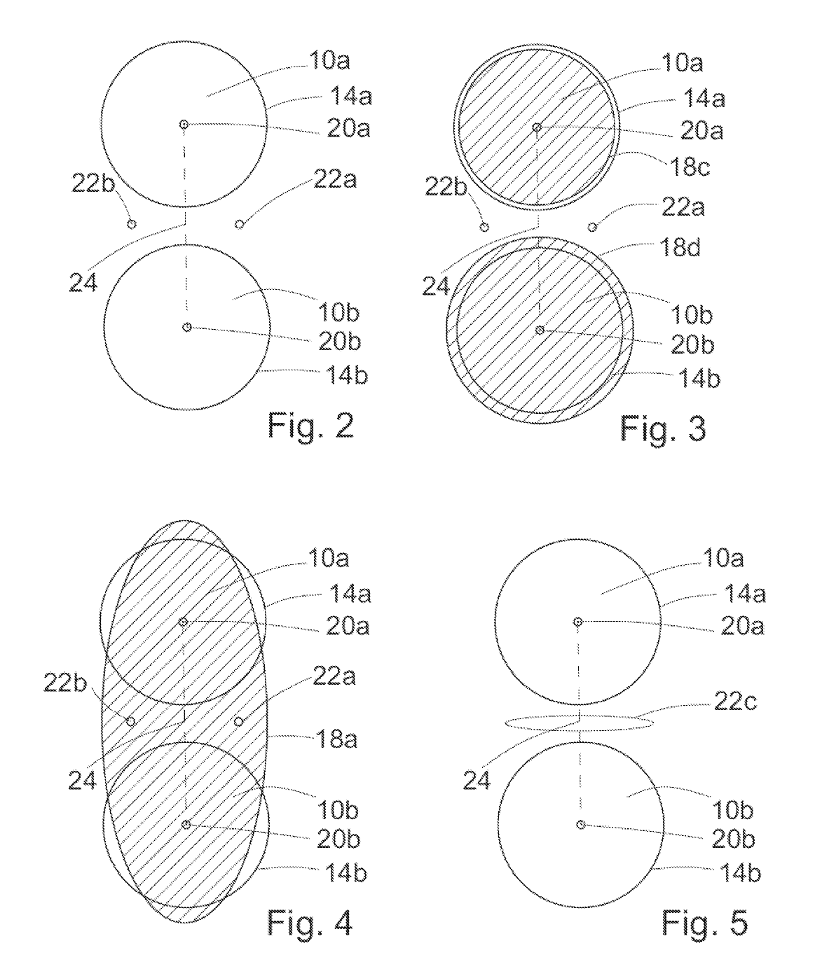

FIG. 2 is a detailed view of two of the heating zones of the hotplate of FIG. 1 with two further cooking utensil sensors arranged between the heating zones,

FIG. 3 is a view of the two heating zones of FIG. 2 with a cooking pot placed on each heating zone,

FIG. 4 is the hotplate of FIG. 2 showing an elongate roasting dish covering both heating zones and the further cooking utensil sensor, and

FIG. 5 is a view of two heating zones of a hotplate with an elongate sensor according to a further embodiment of the invention arranged between the heating zones.

FIG. 1 shows schematically a hotplate having four heating zones 10a to 10d. Arranged under each of the heating zones 10a to 10d is a circular heating element 12a to 12d configured as an inductor. The cooktop surface of the hotplate is substantially conventionally configured, wherein the various heating zones 10a to 10d and heating elements 12a to 12d have different diameters. The edges 14a to 14d of the heating zones 10a to 10d correspond to the edges of the heating elements 12a to 12d in such a manner that the edges 14a to 14d are arranged on a cover plate 16 of the hotplate vertically above the edges of the heating elements 12a to 12d. The edges 14a to 14d are made apparent with markings applied by screen printing. A large cooking utensil element 18a in the form of a roasting dish is placed on both the heating zones 10a and 10b arranged at left in FIG. 1 such that the cooking utensil element 18a largely covers both the heating zones 10a, 10b.

The hotplate has a hotplate device with a cooking utensil sensor unit 28. The cooking utensil sensor unit 28 has cooking utensil sensors 20a to 20d and a cooking utensil sensor unit 28. The cooking utensil sensors 20a to 20d are arranged in the center of the heating zones 10a to 10d and of the heating elements 12a to 12d and preferably comprise induction coils, while in alternative exemplary embodiments of the invention, said heating elements can also operate capacitively or optically. The cooking utensil sensors 20a to 20d provide a characteristic having information concerning a cooking utensil element 18a, 18c, 18d placed on each heating zone 10a to 10d. The cooking utensil sensor unit 28 also has a bridging detection unit 30 with signal coupling means and an evaluation unit 32. The evaluation unit 32 is configured partially integral with a control and/or regulating unit 26. The signal coupling means are configured integral with the cooking utensil sensors 20a to 20d, but can alternatively be configured separately. The signal coupling means couple a signal into a cooking utensil element 18a, 18c, 18d during operation. In this event, the signal is configured as an inductive signal. The cooking utensil element 18a conducts the signal. If the cooking utensil element 18a bridges two heating zones, the cooking utensil sensor 20a to 20d of one of the heating zones 10a to 10d detects the signal of a signal coupling means of another of the heating zones 10a to 10d. Alternatively or additionally, a cooking utensil sensor of one heating zone can also detect a temperature of another heating zone. The evaluation unit 32 detects the transmission of the energy. The bridging detection unit 30 is therefore provided to detect transference of one form of energy from one of the heating zones 10a to 10d to one of the other heating zones 10a to 10d.

A further cooking utensil element 18b is arranged on the heating zone 10c, the diameter of said cooking utensil element essentially corresponding to the diameter of the heating zone 10c.

FIG. 2 shows the two heating zones 10a, 10b of the hotplate of FIG. 1 in a detailed representation. Apart from the cooking utensil sensors 20a, 20b of the hotplate in the center of the heating zone 10a, 10b, the bridging detector unit 30 comprises two further cooking utensil sensors 22a, 22b. The further cooking utensil sensors 22a, 22b are arranged outside the edges 14a, 14b beneath the cover plate 16 made of glass or vitreous ceramic in an inactive region of the hotplate. The further cooking utensil sensors 22a, 22b are at a distance in the range of approximately 3 cm to 5 cm from the edges 14a, 14b of the heating zones 10a, 10b, so that they do not respond even if a round cooking utensil element with a diameter exceeding the diameter of the relevant heating zone 10a, 10b by less than 5 cm is placed centrally on the relevant heating zone 10a, 10b. The distances of the other cooking utensil sensors 22a, 22b from the edges 14a, 14b of the two heating zones are equal. If the diameters of the two heating zones 10a, 10b are also equal, so too are the distances from the center points of the two heating zones 10a, 10b. The other cooking utensil sensors 22a, 22b are therefore provided to detect a cooking utensil element 18a in an inactive region of the cover plate 16 between the two heating zones 10a-10d.

The two other cooking utensil sensors 22a, 22b are arranged symmetrically in relation to a connecting line 24 between the mid-points of the two heating zones 10a, 10b.

FIG. 3 shows the section of the hotplate of FIG. 2 in a configuration with two cooking utensil elements 18c, 18d, the diameters of which do not exceed or only slightly exceed the diameter of the respective heating zones 10a, 10b and which are placed centrally on the heating zones 10a, 10b. The two further cooking utensil sensors 22a, 22b are therefore not covered by the base of the cooking utensil elements 18c, 18d, so that said further cooking utensil sensors do not respond. The cooking utensil sensors 20a, 20b arranged in the center of the heating zones 10a, 10b, however, are each completely covered by the base of the respective cooking utensil elements 18c, 18d, so that said cooking utensil sensors 20a, 20b respond. The control and/or regulating unit 26 shown schematically in FIG. 1 picks up the signals of the cooking utensil sensors 20a to 20d and 22a, 22b in order to detect on which of the heating zones 10a-10d a cooking utensil element 18c, 18d is placed and whether possibly a large, elongate cooking utensil element 18a of the type shown in FIG. 1 covers both the heating zones 10a, 10b. In the configuration shown in FIG. 3, the control and/or regulating unit 26 concludes from the fact that both further cooking utensil sensors 22a, 22b do not respond, that two individual independent cooking utensil elements 18c, 18d are placed on the two heating zones 10a, 10b.

FIG. 4 shows a configuration in which an elongate cooking utensil element 18a configured as a roasting dish is placed on the hotplate such that both heating zones 10a, 10b are covered. Both the cooking utensil sensors 20a, 20b within the heating zones 10a, 10b and the cooking utensil sensors 22a, 22b outside the active regions of the heating zones 10a, 10b respond. The control and/or regulating unit 26 (FIG. 1) concludes therefrom that rather than independent cooking utensil elements, only one single cooking utensil element 18a is placed thereon, covering both the heating zones 10a, 10b. As a result of this detection, the control and/or regulating unit 26 operates both the heating zones 10a, 10b in a manner matched to one another, particularly with the same heating frequency and/or the same heat output per unit area. In particular, the heating output can be selected by the user for heating the cooking utensil element 18a by means of a single input with a single operating element. The heating zones 10a, 10b are grouped together in this way to a common, large heating zone. The control and/or regulating unit 26 can visualize the allocation of the operating element to the combined heating zone, for example, with a display.

The further sensors 22a, 22b can be arranged between a particular pair of heating zones 10a, 10b or alternatively between each pair of adjacent heating zones 10a-10d.

FIG. 5 shows two heating zones 10a, 10b of a hotplate with an elongate sensor 22c according to a further embodiment of the invention arranged between the heating zones 10a, 10b. The sensor 22c replaces the two further cooking utensil sensors 22a, 22b of FIGS. 2-4.

Reference characters

| 10a | Heating zone |
|---|---|
| 10b | Heating zone |
| 10c | Heating zone |
| 10d | Heating zone |
| 12a | Heating element |
| 12b | Heating element |
| 12c | Heating element |
| 12d | Heating element |
| 14a | Edge |
| 14b | Edge |
| 14c | Edge |
| 14d | Edge |
| 16 | Cover plate |
| 18a | Cooking utensil element |
| 18b | Cooking utensil element |
| 18c | Cooking utensil element |
| 18d | Cooking utensil element |
| 20a | Cooking utensil sensor |
| 20b | Cooking utensil sensor |
| 20c | Cooking utensil sensor |
| 20d | Cooking utensil sensor |
| 22a | Cooking utensil sensor |
| 22b | Cooking utensil sensor |
| 22c | Cooking utensil sensor |
| 24 | Connecting line |
| 26 | Control and/or regulating unit |
| 28 | Cooking utensil sensor unit |
| 30 | Bridging detection unit |
| 32 | Evaluation unit |

1-13. (canceled)

14. A hotplate apparatus for a hotplate having a cover plate with at least two heating zones, said hotplate apparatus comprising a cooking utensil sensor unit having at least one bridging detection unit which is provided to detect at least one bridging of the at least two heating zones by at least one cooking utensil element.

15. The hotplate apparatus of claim 14, further comprising a control and/or regulating unit configured for operating the two heating zones in a manner matched to one another, dependent at least on the cooking utensil sensor unit.

16. The hotplate apparatus of claim 14, wherein the bridging detection unit is configured to detect transference of energy from one of the heating zones to another of the heating zones.

17. The hotplate apparatus of claim 14, wherein the bridging detection unit has at least one cooking utensil sensor which is provided to detect a cooking utensil element in an inactive region of the cover plate between the two heating zones.

18. The hotplate apparatus of claim 17, wherein the cooking utensil sensor is arranged at a distance of at least 3 cm from edges of the heating zone.

19. The hotplate apparatus of claim 17, wherein the cooking utensil sensor is arranged at a same distance from edges of the two heating zones.

20. The hotplate apparatus of claim 17, wherein the cooking utensil sensor is arranged symmetrically in relation to a connecting line between two mid-points of the two heating zones in the inactive region of the cover plate outside the two heating zones.

21. The hotplate apparatus of claim 17, wherein the cooking utensil sensor is elongate and is arranged transversely to a connecting line of two mid-points of the two heating zones in the inactive region of the cover plate outside the two heating zones.

22. The hotplate apparatus of claim 14, wherein the hotplate has exactly four heating zones.

23. The hotplate apparatus of claim 14, wherein the heating zones comprise heating elements which are inductors.

24. The hotplate apparatus of claim 14, wherein the cooking utensil sensor unit has at least two cooking utensil sensors forming inductors within the heating zones.

25. The hotplate apparatus of claim 14, wherein the cooking utensil sensor unit has at least one cooking utensil sensor which is an inductive sensor.

26. A hotplate, comprising:
a cover plate with at least two heating zones; and
a hotplate apparatus including a cooking utensil sensor unit having at least one bridging detection unit which is provided to detect at least one bridging of the at least two heating zones by at least one cooking utensil element.

27. The hotplate of claim 26, wherein the hotplate apparatus includes a control and/or regulating unit configured for operating the two heating zones in a manner matched to one another, dependent at least on the cooking utensil sensor unit.

28. The hotplate of claim 26, wherein the bridging detection unit is configured to detect transference of energy from one of the heating zones to another of the heating zones.

29. The hotplate of claim 26, wherein the bridging detection unit has at least one cooking utensil sensor which is provided to detect a cooking utensil element in an inactive region of the cover plate between the two heating zones.

30. The hotplate of claim 29, wherein the cooking utensil sensor is arranged at a distance of at least 3 cm from edges of the heating zone.

31. The hotplate of claim 29, wherein the cooking utensil sensor is arranged at a same distance from edges of the two heating zones.

32. The hotplate of claim 29, wherein the cooking utensil sensor is arranged symmetrically in relation to a connecting line between two mid-points of the two heating zones in the inactive region of the cover plate outside the two heating zones.

33. The hotplate of claim 29, wherein the cooking utensil sensor is elongate and is arranged transversely to a connecting line of two mid-points of the two heating zones in the inactive region of the cover plate outside the two heating zones.

34. The hotplate of claim 26, wherein the cover plate has exactly four heating zones.

35. The hotplate of claim 26, further comprising heating elements configured as inductors for the heating zones.

36. The hotplate of claim 26, wherein the cooking utensil sensor unit has at least two cooking utensil sensors forming inductors within the heating zones.

37. The hotplate of claim 26, wherein the cooking utensil sensor unit has at least one cooking utensil sensor which is an inductive sensor.
